(19) United States
(12) Patent Application Publication
(10) Pub. No.: US 2002/0137491 A1
(43) Pub. Date: Sep. 26, 2002

(54) Method and system for an answering service

(76) Inventors: Heimo Pentikainen, Oulu (FI); Janne Kuvaja, Oulu (FI)

Correspondence Address: Altera Law Group LLC, 10749 Bren Road East Opus 2, Minneapolis, MN, 55343, US

(21) Appl. No.: 09/817,854

(22) Filed: Mar. 26, 2001

Related U.S. Application Data
(63) Continuation of application No. PCT/FI99/00788, filed on Sep. 24, 1999.

(30) Foreign Application Priority Data
Sep. 24, 1998 (FI) 982061

(51) Int. Cl. H04M 11/10

(52) U.S. Cl. 455/412; 455/466; 455/3.05

(57) ABSTRACT

Method for transmitting the status of an answering service comprised in a local exchange in a telecommunication system comprising a local exchange (LE), an answering service (1) connected to the local exchange, an access node (AN) connected to the local exchange, a wireless communication system (WLL) connected to the access node and a telecommunication terminal (MS) connected via the wireless communication system to the access node. In the method, a port-specific connection from the access node (AN) to the local exchange (LE) is set up, the status of the answering service (1) is verified in the access node (AN) and, based on the status of the answering service (1), an announcement is sent from the access node (AN) to the telecommunication terminal (MS). The system comprises means (2) for setting up a port-specific connection to the local exchange (LE), means (3) for verifying the status of the answering service (1) and means (4) for sending an announcement to the telecommunication terminal (MS) on the basis of the status of the answering service (1).

### FIELD OF THE INVENTION

The present invention relates to telecommunication systems, especially WLL systems.

### BACKGROUND OF THE INVENTION

‘WLL system’ (WLL, Wireless Local Loop) refers to a system in which a subscriber is connected to a telephone network via a wireless communication system. The wireless communication system can be implemented by applying mobile communication technology, e.g. GSM technology (GSM, Global System for Mobile Communications). A subscriber connection is achieved by using a special telecommunication terminal. In the WLL system, the telecommunication terminal is connected via a radio link to an access node. Between the terminal and the access node there is a base station, by means of which call signals received by radio from the terminal to the base station are transmitted via the access node further to a public telephone network and vice versa. The access node can be connected to a telephone exchange e.g. using the V5.1 or V5.2 protocol.

Open interfaces (V5.1 and V5.2) between an access node and a telephone exchange are defined in the ETSI (European Telecommunications and Standards Institute) standards of the ETS 300 324 and ETS 300 347 series. V5 interfaces enable subscribers belonging to a physically separate access network, either wired or wireless, to be connected using a standard telephone exchange interface.

In prior art, telephone answering functions in a WLL system are implemented using an answering service connected to a local exchange. In other words, the answering service is implemented in a wired telephone network. The user of a telecommunication terminal in a WLL system has to check the state of the answering service separately by listening to a reminding dialling tone given by the local exchange. However, to do this, the user must establish a connection via a radio link to the access node and further to the local exchange, which means that radio link resources are occupied to no good purpose.

The object of the present invention is to eliminate the drawbacks described above or at least to significantly reduce them. A specific object of the invention is to disclose a new type of method and system for implementing the indication of answering service status data to the user of a telecommunication terminal in a WLL system.

A further object of the invention is to make the use of an answering service easier and simpler. A concurrent object of the invention is to reduce unnecessary use of radio link resources.

### BRIEF DESCRIPTION OF THE INVENTION

The invention concerns a method for transmitting in a telecommunication system the status data of an answering service comprised in a local exchange. The telecommunication system comprises a local exchange, an answering service connected to the local exchange, an access node connected to the local exchange, a wireless communication system connected to the access node and a telecommunication terminal connected via the wireless communication system to the access node. ‘Port’ refers to a point in a telecommunication network where an interface for a subscriber terminal is provided. In the method of the invention, a port-specific connection from the access node to the local exchange is established, the statue of the answering service is verified in the access node and, based on the status of the answering service, an announcement is sent from the access node to the telecommunication terminal.

In an embodiment, a port-specific connection is set up from the access node to the local exchange by opening a port-specific audio channel from the access node to the local exchange. The audio channel is only opened for the access node, in other words, the telecommunication terminal is not informed of this and does not take any part in the establishment of the connection. The local exchange gives in the audio channel a signal tone, which may be e.g. a normal dial tone or a reminding dial tone. The dial tone is a signal tone indicating that the caller may dial a desired telephone number. When the terminal used is subject to an exceptional condition, the normal dial tone may be replaced with a reminding dial tone. Regardless of this, calls can be made from the subscription as normal. The status of the answering service is preferably verified on the basis of the signal tone. If the access node detects by the signal tone that a message has arrived in the answering service, then, according to an embodiment, an announcement regarding the message received in the answering service is sent to the telecommunication terminal. The announcement is preferably sent as a short message.

In a preferred embodiment of the invention, the status of the answering service is verified at predetermined points of time. The status of the answering service may be verified in conjunction with a call event, in which case, when a call is made from a subscription using a telecommunication terminal, the access node waits for a signal tone before connecting the call.

The invention also relates to a system for transmitting, in a telecommunication system as described above, the status data of an answering service comprised in a local exchange. In the system of the invention, the access node comprises means for establishing a port-specific connection to the local exchange, means for checking the status of the answering service and means for sending an announcement based on the status of the answering service to the telecommunication terminal.

In a preferred embodiment of the invention, the access node comprises means for setting up a port-specific connection to the local exchange by opening an audio channel from the access node to the local exchange. These means do not set up a connection to the telecommunication terminal at the sane time, but this function is performed invisibly to the terminal. The access node preferably comprises means for verifying the status of the answering service on the basis of the signal tone heard on the audio channel.

In a preferred embodiment, the access node comprises means for sending an announcement to the telecommunication terminal if a message has been received in the answering service. The access node preferably comprises means for sending the announcement to the terminal in the form of a short message.

The status of the answering service can be verified at different points of time. In an embodiment, the system comprises means for verifying the status of the answering service at predetermined points of time. In an embodiment, the system comprises means for verifying the status of the answering service in conjunction with a call event on the telecommunication terminal.

The invention provides several advantages as compared with prior art. The invention reduces the use of radio link resources; this helps maximise the radio link capacity so that it can be used by another application. The user of a telecommunication terminal need not check the status of his/her answering service as the invention provides an announcement to the telecommunication terminal regarding messages received in the answering service. The user is freed from the necessity to regularly check the answering service. In addition, the invention is independent of the functions of the exchange and therefore it is also manufacturer-independent; even if the signal tone or reminding dial tone of the exchange should differ from the normal tones, the access node can still be configured to recognise such a signal tone, too.

### LIST OF ILLUSTRATIONS

In the following, the invention will be described by the aid of a few examples of its embodiments with reference to the attached drawing, wherein

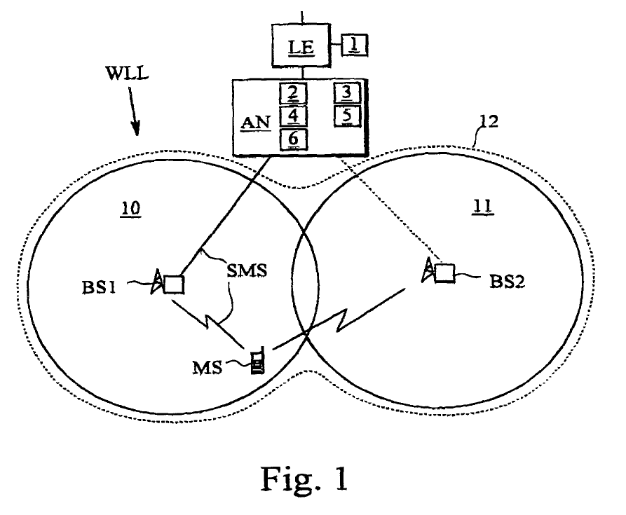

FIG. 1 presents a diagrammatic illustration of a system according to the invention; and

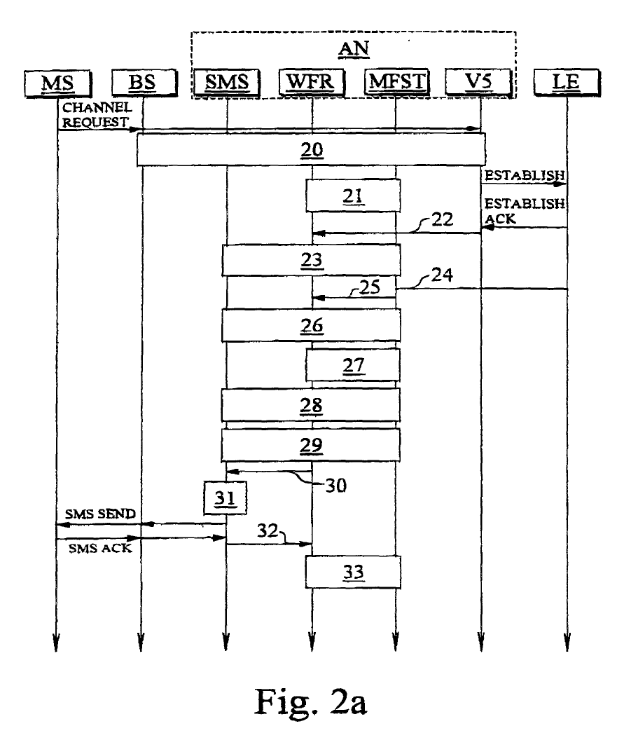

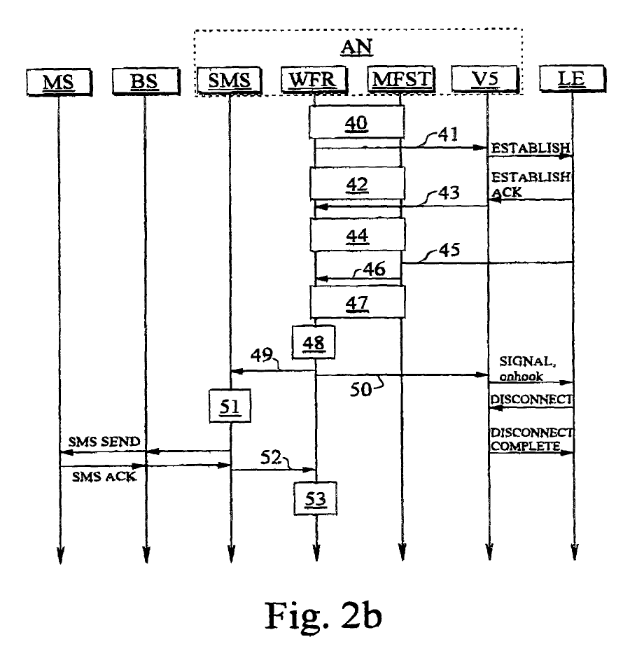

FIGS. 2a-2b present signalling sequences according to the invention.

### DETAILED DESCRIPTION OF THE INVENTION

FIG. 1 presents the components of a system according to the invention. In a WLL system, a telecommunication terminal MS is connected via a wireless communication system WLL to an access node AN, which way be a DAX-node 5000 WLL manufactured by Nokia. The wireless communication system comprises at least one base station BS, which is connected via an Abis interface to the access node AN; in the example in FIG. 1, there are two base stations BS1 and BS2, forming cell areas 10 and 11. The access node AN controls the operation of the base stations BS. The cell areas 10 and 11 together form a mobility area 12, which is an operating area defined for the telecommunication terminal MS. The access node AN is connected via a VS interface to the local exchange LE, so that, as seen by the local exchange LE, the telecommunication terminal MS in the WLL system is a normal wired network subscriber.

Implemented in conjunction with the local exchange LE is an answering service 1. The answering service 1 indicates its status by means of a signal tone. If a message has arrived in the answering service 1, then the answering service will give a signal tone that is different from the normal tone. The signal tone may differ from the normal dial tone e.g. in respect of frequency or duration of silence. The answering service may also give the feedback e.g. in the form of speech.

Moreover, the access node AN comprises a short-message service unit SMS, a subscriber data register WFR (Wireless Fixed Register), a multi-frequency signalling terminal MFST and a V5 interface. The subscriber data register WFR is used to maintain all subscriber information, i.e. to verify e.g. whether the subscriber's terminal is connected to the network, a short message being only sent to a terminal connected to the network. The multi-frequency signalling terminal MFST analyses the audio channel and detects any reminding signal tones.

The access node AN comprises means 2 by which the access node establishes a connection to the local exchange LE. The connection is set up by opening a port-specific audio channel between the access node AN and the local exchange LE. The telecommunication terminal MS is not aware of the audio channel opened. In other words, the access node AN monitors the signal tone of the local exchange LE at the port for the telecommunication terminal without transmitting the signal tone to the terminal MS.

The access node AN verifies the status of the answering service 1 on the basis of the signal tone using means 3. These means 3 may comprise e.g. a device capable of sound recognition or a program connected to the audio channel for interpreting the sound signal received. The sound signal is compared with a number of responses produced by the answering service and stored in the means 3. In an embodiment, the multi-frequency signalling terminal MFST analyses the tone in the audio channel and informs the register WFR about the type of the tone.

If it is detected by means 3 that a new message has been received in the answering service 1, then the access node AN, using means 4, will send to the telecommunication terminal MS an announcement concerning the new message. The announcement may be e.g. a short message SMS containing the information “Voice Message Waiting”. The telecommunication terminal MS, manufactured e.g. by Nokia, now shows a picture of an envelope on its display, where the user can see it. The telecommunication terminal MS may also use other expedients to indicate receipt of a message, e.g. a sound signal or a signal light.

The status of the answering service can be verified at different points of time. Using means 5, the access node AN checks the status of the answering service 1 at predetermined points of time, e.g. periodically upon the lapse of a given period of time. Using means 6, the status of the answering service is checked in conjunction with a call event on the telecommunication terminal MS.

FIG. 2a presents a diagram representing a signalling sequence according to the invention and the processes occurring in the access node in a situation where answering service status data is transmitted to the telecommunication terminal in conjunction with a call event.

The terminal MS sends a CHANNEL REQUEST message, asking the telecommunication system for a free channel. At stage 20, call setup is started. The access node AN informs the local exchange LE about the call start by sending it an ESTABLISH V5-message. The local exchange LE acknowledges the call start by sending an ESTABLISH ACK V5-message to the access node AN. At stage 21, the signal tone indicating a message received in the answering service 1 is checked in a database. The audio channel between the access node AN and the local exchange LE has been opened and this information is transmitted to the register WFR at stage 22. The register WFR requests the group switch control program block to connect the audio channel and the access node marker is instructed to make a connection to the multi-frequency signalling terminal MFST, stage 23. At stage 24, an audio channel between the access node AN and the local exchange LE has been opened. After this, the signal tone transmitted by the local exchange LE is analysed in the access node AN.

At stage 25, the multi-frequency signalling terminal MFST sends the register WFR information indicating the type of the signal tone. At stage 26, the software compares the signal tone type with predefined signal tones. The operation of the software is divided into two parts depend on whether a message or announcement regarding a message received in the answering service 1 is to be transmitted to the terminal MS or not. If an announcement is to be sent, then the procedure goes on to stage 27, where the transmission of an announcement to the terminal MS is defined to be executed. Otherwise, the call setup procedure is continued as normal and the message transmission program is exited. At stage 28, call setup goes on in the normal manner and the audio channel between the access node AN and the local exchange LE is disconnected from the multi-frequency signalling terminal MFST. At stage 29, the call has been set up, whereupon the register WFR sends to the short-message service unit SMS a request 30 to send a short message to the terminal MS. The short-message service unit SMS generates the short message to be sent to the terminal MS, stage 31. The short-message service unit SMS and the register WFR constitute the means 4 for sending a short message.

The short-message service unit SMS of the access node AN sends the short message to the terminal MS using a SMS SEND message. The terminal MS acknowledges receipt of the short message by returning a SMS ACK message to the short-message service unit SMS. The short-message service unit SMS acknowledges transmission of the short message by sending a message 32 to the register WFR. The call setup process is continued in the normal manner at stage 33.

FIG. 2b is diagrammatic representation of a signalling sequence according to the invention and the processes occurring in the access node in a situation where the answering service status data is checked at regular intervals. At stage 40, a program in the register WFR of the access node AN detects a predetermined point of time for verifying the status of the answering service 1. The predetermined point of time is e.g. a parametrised data item in the register program, such as periodic check repeated at regular six-hour intervals or a suitable time of day. At this point, the program in question implements the action of the means 5 for verifying the status of the answering service 1. If it is detected by the data in the register WFR, e.g. by the IMSI attach/detach data, that the subscriber's telecommunication terminal has been detached from the network, then the verification can be omitted for the subscriber in question. The IMSI attach/detach data is stored in the access node AN as a status flag, the status being changed when the terminal MS is connected to or disconnected from the wireless communication system WLL. The register WFR sends to the VS interface a message 41 for the setup of a virtual call to the local exchange. The access node AN starts a virtual call to the local exchange LE by sending an ESTABLISH V5-message. The initiative for call setup has thus been received from the access node AN, not from the telecommunication terminal MS.

At stage 42, the signal tone used to indicate a message received in the answering service 1 is checked in the calendar database WFR. The local exchange LE acknowledges the virtual call setup request with an ESTABLISH ACK V5-message. After the audio channel between the access node AN and the local exchange LE has been opened, a message 43 indicating this is sent from the V5 interface to the register WFR. The register WFR requests the group switch control program block of the local exchange LE to connect the audio channel, and the audio channel is connected to the multi-frequency signalling terminal MFST by means of a switching unit, stage 44. The audio channel between the local exchange LE and the multi-frequency signalling terminal has been opened at stage 45. Using means 3, the signal tone transmitted by the local exchange LE can now be analysed. In an embodiment, the multi-frequency signalling terminal MFST identifies the signal tone and forms from the tone type an identifier for use by other applications. The multi-frequency signalling terminal MFST informs the register WFR about the signal tone type by sending a message 46.

At stage 47, the program is divided into two branches, and the action to be executed depends on whether an announcement about a message received in the answering service 1 is to be sent to the terminal MS. If an announcement is to be sent, then the procedure is continued at stage 48, otherwise the virtual call is disconnected by means of message 50. At stage 48, the program sends to the short-message service unit SMS a request 49 to send a short message indicating the status of the answering service 1 to the terminal MS. After this , the virtual call is disconnected by means of message 50, as a result of which a SIGNAL V5-message is sent to the local exchange LE, containing an “onhook” information element which disconnects the call. The local exchange LE responds by returning a DISCONNECT message, which is further acknowledged by the access node AN with a DISCONNECT COMPLETE message. At stage 51, the short-message service unit SMS generates a short message to be sent to the terminal MS and displayed. The access node AN sends the short message to the terminal MS using a SMS SEND message. The terminal MS acknowledges receipt of the short message by sending a SMS ACK message to the access node AN. With message 52, the short-message service unit SMS acknowledges transmission of the short message to the register WFR. Execution of the program is ended at stage 53.

The invention is not restricted to the examples of its embodiments described above, but many variations are possible within the scope of the inventive idea defined in the claims.

1. Method for transmitting the status data of an answering service comprised in a local exchange in a telecommunication system comprising a local exchange (LE), an answering service (1) connected to the local exchange, an access node (AN) connected to the local exchange, a wireless communication system (WLL) connected to the access node and a telecommunication terminal (MS) connected via the wireless communication system to the access node, characterised in that a port-specific connection is set up from the access node (AN) to the local exchange (LE), the status of the answering service (1) is verified in the access node (AN) and, based on the status of the answering service (1), an announcement is sent from the access node (AN) to the telecommunication terminal (MS).

2. Method as defined in claim 1, characterised in that the port-specific connection is set up by opening an audio channel from the access node (AN) to the local exchange (LE).

3. Method as defined in claim 1 or 2, characterised in that the status of the answering service (1) is verified on the basis of a signal tone given by the local exchange (LE).

4. Method as defined in any one of claims 1-3, characterised in that an announcement regarding a message received in the answering service (1) is sent to the telecommunication terminal (MS).

5. Method as defined in any one of claims 1-4, characterised in that the announcement to the telecommunication terminal (MS) is sent in the form of a short message (SMS).

6. Method as defined in any one of claims 1-5, characterised in that the status of the answering service (1) is verified at predetermined points of time.

7. Method as defined in any one of claims 1-6 characterised in that the status of the answering service (1) is verified in conjunction with a call event on the telecommunication terminal (MS).

8. System for transmitting the status data of an answering service comprised in a local exchange in a telecommunication system comprising a local exchange (LE), an answering service (1) connected to the local exchange, an access node (AN) connected to the local exchange, a wireless communication system (WLL) connected to the access node and a telecommunication terminal (MS) connected via the wireless communication system to the access node, characterised in that the access node (AN) comprises means (2) for setting up a port-specific connection to the local exchange (LE), means (3) for verifying the status of the answering service (1) and means (4) for sending an announcement to the telecommunication terminal (MS) on the basis of the status of the answering service (1).

9. System as defined in any one of claims 8, characterised in that the access node (AN) comprises means (2) for setting up a port-specific connection to the local exchange (LE) by opening an audio channel from the access node (AN) to the local exchange (LE).

10. System as defined in claim 8 or 9, characterised in that the access node (AN) comprises means (3) for verifying the status of the answering service (1) on the basis of a signal tone.

11. System as defined in any one of claims 8-10, characterised in that the access node (AN) comprises means (4) for sending to the telecommunication terminal (MS) an announcement indicating that a message has been received in the answering service (1).

12. System as defined in any one of claims 8-11, characterised in that the access node (AN) comprises means (4) for sending to the telecommunication terminal (MS) an announcement in the form of a short message (SMS).

13. System as defined in any one of claims 8-12, characterised in that the system comprises means (5) verifying the status of the answering service (1) at predetermined points of time.

14. System as defined in any one of claims 8-13, characterized in that the system comprises means (6) for verifying the status of the answering service in conjunction with a call event on the telecommunication terminal (MS).
